(19) United States
(12) Patent Application Publication
(10) Pub. No.: US 2010/0150730 A1
(43) Pub. Date: Jun. 17, 2010

(54) COMPONENT HAVING AN ABRASIVE LAYER AND A METHOD OF APPLYING AN ABRASIVE LAYER ON A COMPONENT

(75) Inventors: Christopher Sellars, Derby (GB); Matthew Hancock, Derbyshire (GB)

Correspondence Address: MCCORMICK, PAULDING & HUBER LLP, CITY PLACE II, 185 ASYLUM STREET, HARTFORD, CT, 06103, US

(73) Assignee: ROLLS-ROYCE PLC, London (GB)

(21) Appl. No.: 12/613,906

(22) Filed: Nov. 6, 2009

(30) Foreign Application Priority Data
Dec. 15, 2008 (GB) 0822703.5

(51) Int. Cl. F01D 5/28; B05D 5/02; C23C 4/10; C25D 7/00; C25D 3/00; B23P 15/02

(52) U.S. Cl. 416/241 R; 428/149; 205/110; 427/450; 427/554; 427/201; 29/889.7

(57) ABSTRACT

The tips of gas turbine engine turbine rotor blades are provided with an abrasive layer and the abrasive layer comprises chromised silicon carbide grit protruding from a layer of material. In particular the abrasive layer comprises a mixture of cubic boron nitride grit and chromised silicon carbide grit and the cubic boron nitride grit and the chromised silicon carbide grit protruding from the layer of material. The cubic boron nitride grit has a greater dimension than the chromised silicon carbide grit. The cubic boron nitride grit cuts the majority of a track in an abradable structure and then the chromised silicon carbide grit provides any additional cutting of the abradable structure.

### CROSS REFERENCE TO RELATED APPLICATION

This application is entitled to the benefit of British Patent Application No. GB 0822703.5, filed on Dec. 15, 2008.

### FIELD OF THE INVENTION

The present invention relates to a component having an abrasive layer and in particular to a gas turbine engine turbine rotor blade having an abrasive layer or a gas turbine engine compressor rotor blade having an abrasive layer.

### BACKGROUND OF THE INVENTION

Cubic boron nitride grit is used in an abrasive layer on the tips of gas turbine engine turbine rotor blades and/or compressor rotor blades to cut a track in an abradable material on a surrounding casing to form a seal between the tips of the rotor blades and the casing.

Cubic boron nitride suffers from high temperature oxidation, e.g. cubic boron nitride has a relatively short oxidation life, about 25 hours, at the operating temperature of a turbine of a gas turbine engine. This reduces the cutting performance of the cubic boron nitride grit at later stages in the operational life of the turbine of a gas turbine engine. However, cubic boron nitride grit is still of interest for use in the turbine of a gas turbine engine because cubic boron nitride is able to cut into ceramic abradable material and the majority of the cutting of the track in the abradable material occurs during initial running-in of the gas turbine engine.

Our European patent EP0517463B1 discloses an abrasive layer for a turbine blade comprising cubic boron nitride grit coated with aluminium nitride.

The aluminium nitride reduces, or prevents, oxidation of the cubic boron nitride grit.

However, the aluminium nitride is eroded from the cubic boron nitride grit in use and then the cubic boron nitride grit is oxidised.

Silicon carbide grit does not suffer from high temperature oxidation. However, the shear strength and hardness of silicon carbide grit are less than cubic boron nitride grit but silicon carbide grit is able to cut into ceramic abradable material. In addition silicon carbide grit is susceptible to diffusion into the turbine blade nickel based superalloys and produces deleterious silicides in the nickel based superalloy.

Our published UK patent application GB2301110A discloses an abrasive layer for a turbine blade that includes silicon carbide grit coated with aluminium nitride. The aluminium nitride reduces, or prevents, diffusion of the silicon carbide into the nickel based superalloy of the turbine blade.

Alumina grit is not hard enough to cut into ceramic abradable material.

### SUMMARY OF THE INVENTION

Accordingly, the present invention seeks to provide a component having a novel abrasive layer which reduces, Preferably, overcomes, the above mentioned problem.

Accordingly, the present invention provides a component having an abrasive layer, wherein the abrasive layer comprises a mixture of cubic boron nitride grit and chromised silicon carbide grit, the cubic boron nitride grit and the chromised silicon carbide grit protruding from the layer of material, the cubic boron nitride grit having a greater dimension than the chromised silicon carbide grit.

Preferably, the cubic boron nitride grit has a dimension of 100 to 150 micrometers and the chromised silicon carbide grit has a dimension of 40 to 90 micrometers.

Preferably, the cubic boron nitride grit has a dimension of 100 to 150 micrometers and the chromised silicon carbide grit has a dimension of 50 to 80 micrometers.

Preferably, the layer of material includes a metal.

Preferably, the component includes a gas turbine engine component.

Preferably, the gas turbine engine component includes a compressor rotor blade or a turbine rotor blade.

The present invention also provides a method of applying an abrasive layer on a component, having the steps of providing a mixture of cubic boron nitride grit and chromised silicon carbide grit, the cubic boron nitride grit having a greater dimension than the chromised silicon carbide grit and securing the mixture of cubic boron nitride grit and chromised silicon carbide grit to the component using the layer of material.

Preferably, the mixture of cubic boron nitride grit and chromised silicon carbide grit is secured to the component by brazing, or electroplating, the layer of material onto the component.

Alternatively, the mixture of cubic boron nitride grit and chromised silicon carbide grit is secured to the component by direct laser deposition of the layer of material onto the component or by melting the component by direct laser deposition to form the layer of material.

Preferably, the cubic boron nitride grit has a dimension of 100 to 150 micrometers and the chromised silicon carbide grit has a dimension of 40 to 90 micrometers.

Preferably, the cubic boron nitride grit has a dimension of 100 to 150 micrometers and the chromised silicon carbide grit has a dimension of 50 to 80 micrometers.

Preferably, the layer of material comprises a metal.

Preferably, the component is a gas turbine engine component.

Preferably, the gas turbine engine component comprises a compressor rotor blade or a turbine rotor blade.

The present invention also provides a component having an abrasive layer, wherein the abrasive layer comprises chromised silicon carbide grit protruding from a layer of material.

The present invention also provides a method of applying an abrasive layer on a component, comprising providing chromised silicon carbide grit and securing the chromised silicon carbide grit to the component using a layer of material.

### BRIEF DESCRIPTION OF THE DRAWINGS

FIG. 1 shows a turbofan gas turbine engine having a component having an abrasive layer according to the present invention.

FIG. 2 is an enlarged view of a component having an abrasive layer according to the according to the present invention.

FIG. 3 is a further enlarged view of an abrasive layer according to the present invention in a manufactured condition.

FIG. 4 is a further enlarged view of an abrasive layer according to the present invention in a used condition.

### DETAILED DESCRIPTION OF THE PREFERRED EMBODIMENTS

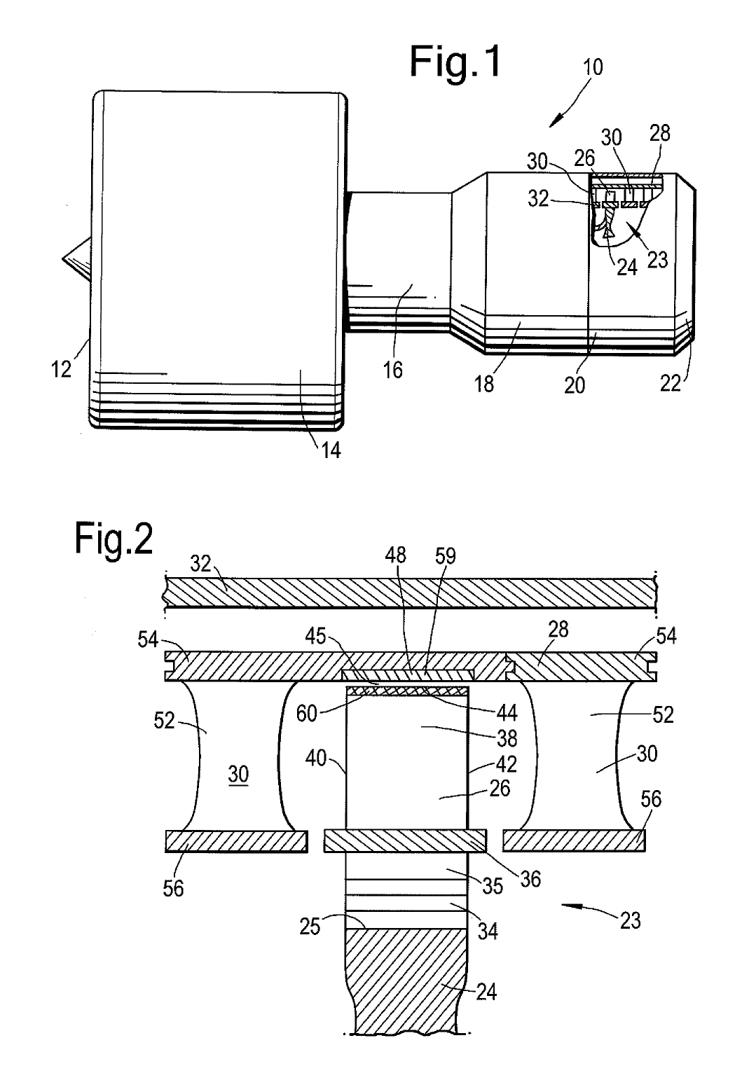

A turbofan gas turbine engine 10, as shown in FIG. 1, comprises in axial flow series an intake 12, a fan section 14, a compressor section 16, a combustion section 18, a turbine section 20 and a core exhaust 22. The turbine section 20 comprises a high-pressure turbine 23 arranged to drive a high-pressure compressor (not shown) in the compressor section 16, an intermediate-pressure turbine (not shown) arranged to drive an intermediate-pressure compressor (not shown) in the compressor section 16 and a low-pressure turbine (not shown) arranged to drive a fan (not shown) in the fan section 14.

The high-pressure turbine 23 of the turbine section 20 is shown more clearly in FIG. 2. The high-pressure turbine 23 comprises one or more stages of turbine rotor blades 26 arranged alternately with one or more stages of stator vanes 30. Each of the turbine rotor blades 26 comprises a root 34, a shank 35, a platform 36 and an aerofoil 38. The turbine rotor blades 26 are arranged circumferentially around a turbine rotor 24 and the turbine rotor blades 26 extend generally radially from the turbine rotor 24. The roots 34 of the turbine rotor blades 26 are located in axially extending slots 25 in the periphery of the turbine rotor 24. The platforms 36 of the turbine rotor blades 26 together define the inner boundary of a portion of the flow path through the high-pressure turbine 23. The aerofoils 38 of the turbine rotor blades 26 have leading edges 40, trailing edges 42 and tips 44 at their radially outer extremities.

Alternatively, the turbine rotor blades 26 are integral with the turbine rotor 24 and are friction welded, electron beam welded or laser beam welded to the turbine rotor 24.

The turbine stator vanes 30 also comprise aerofoils 52, which have platforms 56 at their radially inner ends and shrouds 54 at their radially outer ends. The turbine stator vanes 30 are also arranged circumferentially around the stator and extend generally radially. The shrouds 54 of the turbine stator vanes 30 are secured together to form a stator casing 28. A further outer stator casing 32 surrounds the stator casing 28.

A small gap, or clearance, 45 is provided radially between the tips 44 of the turbine rotor blades 26 and the turbine casing 28. The turbine casing 28 is provided with a seal 48, an abradable structure, on its radially inner surface immediately around the tips 44 of the turbine rotor blades 26.

These seals 48 are provided around each of the stages of the turbine rotor blades 26, between the tips 44 of the turbine rotor blades 26 and the stator casing 28. The seals 48 are carried on the shrouds 54 of the stator vanes 30. The seals 48 comprise an abradable structure 59 on the shrouds 54 of the stator vanes 30 of the turbine casing 28. The seals 48 comprise a ceramic material, for example zirconia or stabilised zirconia.

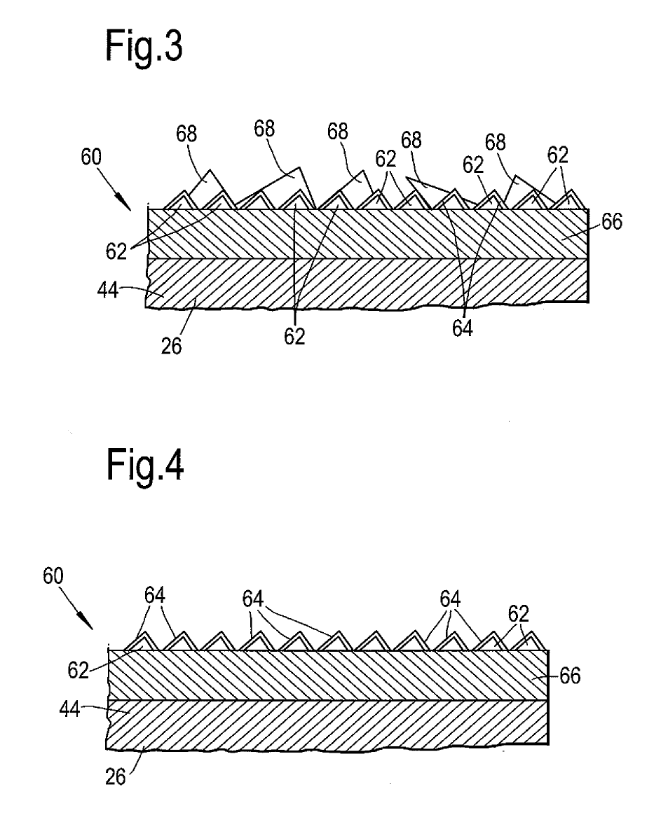

The tips 44 of the turbine rotor blades 26 are provided with an abrasive layer 60, as shown more dearly in FIG. 3, and the abrasive layer 60 comprises chromised 64 silicon carbide grit 62 protruding from a layer of material 66. In particular the abrasive layer 60 comprises a mixture of cubic boron nitride grit 68 and chromised 64 silicon carbide grit 62 and the cubic boron nitride grit 68 and the chromised 64 silicon carbide grit 62 protruding from the layer of material 66. The cubic boron nitride grit 68 has a greater dimension than the chromised 64 silicon carbide grit 62. Thus, the cubic boron nitride grit 62 protrudes a greater distance from the layer of material 66 than the chromised 64 silicon carbide grit 62.

In particular, the cubic boron nitride grit 68 has a dimension of 100 to 150 micrometers and the chromised 64 silicon carbide grit 62 has a dimension of 40 to 90 micrometers. In a particular example the cubic boron nitride grit 68 has a dimension of 100 to 150 micrometers and the chromised 64 silicon carbide grit 62 has a dimension of 50 to 80 micrometers.

The layer of material 66 comprises a layer of metal, for example the layer of metal comprises a MCrAlY, where M is one or more of nickel, cobalt and iron, Cr is chromium, Al is aluminium and Y is yttrium.

The chromised 64 silicon carbide grit 62 comprises silicon carbide grit 62 in which chromium has been diffused into the outer layer of the silicon carbide grit 62. The diffusion of chromium into the outer layer of the silicon carbide grit 62 changes the composition of the outer layer of the silicon carbide grit 62 to form a new alloy. The chromium is diffused into the outer layer of the silicon carbide grit 62 using any suitable process, for example pack chromising or vapour chromising.

The mixture of cubic boron nitride grit 68 and chromised 64 silicon carbide grit 62 is secured to the tips 44 of the turbine rotor blades 26 by brazing or electroplating the layer of material 66 onto the tips 44 of the turbine rotor blades 26.

Alternatively, the mixture of cubic boron nitride grit 68 and chromised 64 silicon carbide grit 62 is secured to the tips 44 of the turbine rotor blades 26 by direct laser deposition of the layer of material 66 onto the tips 44 of the turbine rotor blades 26 or by melting the tips 44 of the turbine rotor blades 26 by direct laser deposition to form the layer of material 66.

As manufactured the cubic boron nitride grit 68 protrudes by a greater distance from the outer surface of the layer of material 68 than the chromised 64 silicon carbide grit 62, as shown in FIG. 3. In operation of the gas turbine engine 10, the cubic boron nitride grit 68 cuts the majority of the track, the cubic boron nitride grit 68 cuts about 90% of the depth of the track, in the abradable structure 59 on the shrouds 54 during the initial running-in in the first 25 hours of operation of the gas turbine engine. During service of the gas turbine engine 10 the cubic boron nitride grit 68 is progressively oxidised leaving only the chromised 64 silicon carbide grit 62, as shown in FIG. 4. The chromisied silicon carbide grit 62 then provides any additional cutting of the abradable structure 59.

Although the present invention has been described with reference to providing the abrasive layer on the tips of gas turbine engine turbine rotor blades, it is equally possible to apply the abrasive layer to the tips of gas turbine engine compressor rotor blades or other gas turbine engine components where it is necessary to cut a track in an abradable material on a cooperating component, e.g., sealing fins on a rotor and abradable structure on a stator vane platform, labyrinth seals. The present invention is applicable to axial and centrifugal flow compressors, axial and radial flow turbines, turbochargers and power turbines.

What is claimed is:

1. A component having an abrasive layer, comprising:
cubic boron nitride grit, and
chromised silicon carbide grit, the cubic boron nitride grit and the chromised silicon carbide grit protruding from a layer of material, the cubic boron nitride grit having a greater dimension than the chromised silicon carbide grit.

2. A component as claimed in claim 1 wherein the cubic boron nitride grit has a dimension of 100 to 150 micrometers and the chromised silicon carbide grit has a dimension of 40 to 90 micrometers.

3. A component as claimed in claim 2 wherein the cubic boron nitride grit has a dimension of 100 to 150 micrometers and the chromised silicon carbide grit has a dimension of 50 to 80 micrometers.

4. A component as claimed in claim 1 wherein the layer of material further comprises a metal.

5. A component as claimed in claim 1 wherein the component further comprises a gas turbine engine component.

6. A component as claimed in claim 5 wherein the gas turbine engine component is selected from the group comprising a compressor rotor blade and a turbine rotor blade.

7. A method of applying an abrasive layer on a component comprising the steps of:
providing a mixture of cubic boron nitride grit,
providing chromised silicon carbide grit to create a mixture,wherein the cubic boron nitride grit has a greater dimension than the chromised silicon carbide grit, and
securing the mixture of cubic boron nitride grit and chromised silicon carbide grit to the component using a layer of material.

8. A method as claimed in claim 7 wherein the mixture of cubic boron nitride grit and chromised silicon carbide grit is secured to the component by the step of brazing the layer of material onto the component.

9. A method as claimed in claim 7 wherein the mixture of cubic boron nitride grit and chromised silicon carbide grit is secure to the component by the step of electroplating the layer of material onto the component.

10. A method as claimed in claim 7 wherein the mixture of cubic boron nitride grit and chromised silicon carbide grit is secured to the component by the step of direct laser deposition of the layer of material onto the component.

11. A method as claimed in claim 7 wherein the mixture of cubic boron nitride grit and chromised silicon carbide grist is secured to the component by the step of melting the component by direct laser deposition to form the layer of material.

12. A method as claimed in claim 7 wherein the cubic boron nitride grit has a dimension of 100 to 150 micrometers and the chromised silicon carbide grit has a dimension of 40 to 90 micrometers.

13. A method as claimed in claim 12 wherein the cubic boron nitride grit has a dimension of 100 to 150 micrometers and the chromised silicon carbide grit has a dimension of 50 to 80 micrometers.

14. A method as claimed in claim 7 wherein the layer of material comprises a metal.

15. A method as claimed in any claim 7 wherein the component is a gas turbine engine component.

16. A method as claimed in claim 15 wherein the gas turbine engine component is selected from the group comprising a compressor rotor blade and a turbine rotor blade.

17. A component having an abrasive layer, wherein the abrasive layer comprises chromised silicon carbide grit protruding from a layer of material.

18. A method of applying an abrasive layer on a component, comprising providing chromised silicon carbide grit and securing the chromised silicon carbide grit to the component using a layer of material.
